(19) United States
(12) Patent Application Publication
(10) Pub. No.: US 2014/0355441 A1
(43) Pub. Date: Dec. 4, 2014

(54) METHOD AND APPARATUS OF DELIVERING ASSURED SERVICES OVER UNRELIABLE INTERNET INFRASTRUCTURE BY USING VIRTUAL OVERLAY NETWORK ARCHITECTURE OVER A PUBLIC CLOUD BACKBONE

(71) Applicant: Ashok Kumar Jain, Sunnyvale, CA (US)

(72) Inventor: Ashok Kumar Jain, Sunnyvale, CA (US)

(21) Appl. No.: 13/970,033

(22) Filed: Aug. 19, 2013

Related U.S. Application Data
(60) Provisional application No. 61/828,583, filed on May 29, 2013.

(51) Int. Cl. H04L 12/851; H04L 12/751

(52) U.S. Cl. CPC H04L 47/2425; H04L 45/02
USPC 370/235; 370/254

(57) ABSTRACT

A method for virtual overlay network architecture includes receiving a request for a virtual overlay network, discovering, by a computer processor, a physical topology for the virtual overlay network and constructing overlay tunnels within the physical topology with at least one elastic hub. The method further includes receiving, by the computer processor, feedback regarding performance of the physical topology of the virtual overlay network, selecting an overlay tunnel of the overlay tunnels for sending a data packet, and sending the data packet using the selected overlay tunnel.

### CROSS-REFERENCE TO RELATED APPLICATIONS

This application claims priority, pursuant to 35 U.S.C. §119(e), to U.S. Provisional Application No. 61/828,583, filed on May 29, 2013, the entirety of which is incorporated by reference herein.

### BACKGROUND

The Internet is a collection of autonomous networks that are interconnected into one cohesive fabric, each individual network has the ability to regulate and traffic engineer itself to prevent long lived congestion (typically measured in seconds) on any of its Wide Area Network (WAN) links. Long lived congestion occurs most frequently at the connection points between the various autonomous networks making up the Internet. Further, the Internet still uses decades old routing technology in which shortest path algorithms are used to route traffic to the nearest neighbor's autonomous set of peering network nodes regardless of traffic conditions Improvements which are able to reduce or eliminate the long lived congestion are needed.

### SUMMARY OF INVENTION

In general, in one aspect, the invention relates to a method for virtual overlay network architecture. The method includes receiving a request for a virtual overlay network, discovering, by a computer processor, a physical topology for the virtual overlay network, constructing a plurality of overlay tunnels within the physical topology, wherein the overlay tunnels comprise at least one elastic hub, receiving, by the computer processor, a feedback regarding performance of the physical topology of the virtual overlay network, selecting a first overlay tunnel of the plurality of overlay tunnels for sending a data packet, and sending the data packet using the first overlay tunnel.

In general, in one aspect, the invention relates to a non-transitory computer readable medium storing instructions for virtual overlay network architecture. The instructions include functionality to receive a request for a virtual overlay network, discover a physical topology for the virtual overlay network, and construct overlay tunnels within the physical topology with at least one elastic hub. The instructions include further functionality to receive feedback regarding performance of the physical topology of the virtual overlay network, select a first overlay tunnel of the overlay tunnels for sending a data packet, and send the data packet using the first overlay tunnel.

In general, in one aspect, the invention relates to a system for virtual overlay network architecture. The system includes at least one elastic hub including functionality to forward packets, and a controller executing on a processor. The controller includes functionality to receive a request for a virtual overlay network, discover a physical topology for the virtual overlay network, construct overlay tunnels within the physical topology with at least one elastic hub, receive feedback regarding performance of the physical topology of the virtual overlay network, select a first overlay tunnel of the overlay tunnels for sending a data packet, and send the data packet using the first overlay tunnel.

Other aspects and advantages of the invention will be apparent from the following description and the appended claims.

### BRIEF DESCRIPTION OF DRAWINGS

FIG. 1 shows a schematic diagram in accordance with one or more embodiments of the invention.

FIG. 2 shows a flowchart of a method in accordance with one or more embodiments of the invention.

FIGS. 3A-3C shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout this specification, Virtual Overlay Network (VON) Architecture as it pertains to this invention will be discussed in depth. A VON allows programmability of network entities for control and data paths. The control channel is concerned with mapping the computer network and/or controlling what to do with packets. The forwarding channel is concerned with looking up the destination of packets arriving at an interface, retrieving the information necessary to get the packets to their destination, and forwarding the packet to their destination. Dependent on the implementation, there may be any number of control channels and any number of forwarding channels. The specifics of the VON architecture using the public cloud infrastructure of the present invention are discussed in detail, below.

In general, embodiments of the invention provide a method and system for VON architecture using the public cloud infrastructure architecture. Initially, a request is received for a virtual overlay network, and the physical topology for the network is discovered. Subsequently, a plurality of overlay tunnels are constructed, with at least one elastic hub, within the physical topology. Feedback regarding the performance of the physical topology is received, and an overlay tunnel is selected for sending data packets. Finally, the data packets are sent using the selected overlay tunnel.

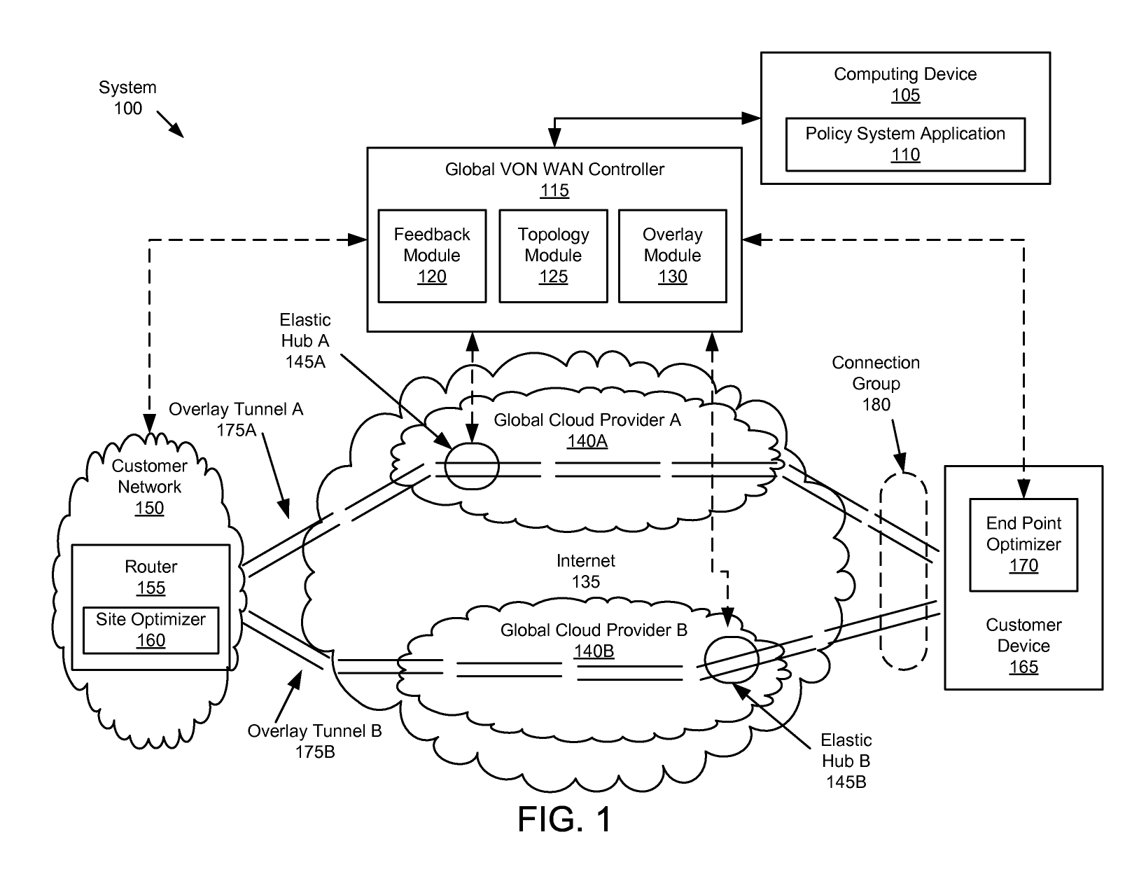

FIG. 1 shows a diagram of a system for virtual overlay network architecture. System (100) includes computing device (105), policy system application (110), global VON WAN controller (115), feedback module (120), topology module (125), overlay module (130), internet (135), global cloud provider A (140A), global cloud provider B (140B), elastic hub A (145A), elastic hub B (145B), customer network (150), router (155), site optimizer (160), customer device (165), end point optimizer (170), overlay tunnel A (175A), overlay tunnel B (175B), and connection group (180). In one or more embodiments of the invention, computing device (105) may be any computing device including, but not limited to: a desktop computer, a laptop computer, a smart phone, a cell phone, a handheld gaming device, a cable box, a server, a rack, etc. Computing device (105) may have a variety of applications installed, such as a financial application, a web browser, etc. Further, computing device (105) may be multiple devices, such as a group of connected computers accessing shared data, as in an office environment.

In one or more embodiments of the invention, policy system application (110) is an application or module that includes functionality for providing a user interface for defining a Service Level Agreement (SLA) and connection policy for a customer. Further, policy system application (110) includes functionality to store policy information and other data including, but not limited to: usage information, user preferences, settings, grooming and/or stickiness policy for stored data, etc. Policy system application (110) is communicatively connected to global VON WAN controller (115).

In one or more embodiments of the invention, global VON WAN controller (115) includes functionality to control the forwarding channel(s) to a desired set of forwarding behaviors. Global VON WAN controller (115) includes the various application programming interfaces (APIs) needed to communicate with the forwarding channel network elements (i.e., site optimizer (160) and end point optimizer (170)). In one or more embodiments of the invention, global VON WAN controller (115) is communicatively connected, via the control channel, to at least elastic hub A (145A), elastic hub B (145B), customer network (150), and end point optimizer (170), as indicated by the dotted lines. Further, global VON WAN controller (115) includes feedback module (120), topology module (125), and overlay module (130).

In one or more embodiments of the invention, feedback module (120) includes functionality for receiving feedback from various network components. The feedback may include data regarding the network performance of associated physical components. Further, feedback module (120) includes functionality for initiating tracking of packets by, for example, injecting syntactic transaction traffic into a given tunnel (i.e., overlay tunnel A (175A) and/or overlay tunnel B (175B)), and/or by marking packets for performance analysis.

In one or more embodiments of the invention, topology module (125) includes functionality to discover the physical topology of a customer's forwarding channel, including any site optimizers or end point optimizers, by determining whether there is one or more Internet facing network interface. Topology module (125) further includes functionality to discover elastic hubs for use as intermediary relay points, and to create the overlay tunnels used for forwarding/sending of packets. In one or more embodiments of the invention, the discovery of the physical topology and elastic hubs may be done in any manner now known or later developed, such as performance statistical analysis on the data gathered by feedback module (120).

In one or more embodiments of the invention, overlay module (130) includes functionality to manage the various overlay tunnels created by topology module (125), and determine which tunnel to use and when to switch to a different tunnel based on performance. Overlay module (130) is aware of the any SLA performance standards set by a customer, and may decide to switch to a different tunnel based on a requirement of an SLA. Overlay module (130) may use data from feedback module (120) for deciding which tunnel to use.

In one or more embodiments of the invention, internet (135) is the global interconnected system of computer networks. Access to internet (135) is provided by internet service providers (ISPs) (not shown).

In one or more embodiments of the invention, global cloud provider A (140A) and global cloud provider B (140B) are businesses or individuals who provide cloud computing functionality to their clients. Cloud computing is essentially distributed computing—the ability to remotely run a program(s) on many computers at once. Many different companies provide cloud services. Typically, access to these cloud services occurs over internet (135). For the purposes of system (100) global cloud provider A (140A) is different than global cloud provider B (140B), although the services offered may be identical.

In one or more embodiments of the invention, elastic hub A (145A) and elastic hub B (145B) are forwarding nodes that perform Internet Protocol (IP) tunnel switching Importantly, elastic hub A (145A) and elastic hub B (145B) may be executed on any general purpose Central Processing Unit (CPU) or Virtual Machine (VM) in a global cloud provider (i.e., global cloud provider A (140A) and/or global cloud provider B (140B)). Thus, elastic hub A (145A) and elastic hub B (145B) may be provisioned on demand on any global cloud provider, thereby immediately giving ubiquitous reach to the system.

In one or more embodiments of the invention, customer network (150) is any public, private, home, enterprise, or other network. Access to customer network (150) may be controlled, for example, by router (155). In one or more embodiments of the invention, router (155) is a router, switch, or other suitable device for sending packets between different computer networks. It will be apparent to one of ordinary skill in the art, having the benefit of this disclosure, that customer network (150) may be configured in many different ways, and as such, the invention should not be limited to the above examples.

In one or more embodiments of the invention, site optimizer (160) is a module or program of router (155) that includes functionality to proxy traffic from all devices at a given customers site to the system for performance tagging, tunneling, and security services. Site optimizer (160) is able to provide this functionality for the entire customer network (150). Thus, if a site optimizer (160) is present on a network, end point optimizer (170) is not required. Site optimizer (160) may proxy traffic, tag, tunnel, and provide security services in any manner now known or later developed. In one or more embodiments of the invention, the security services provided by site optimizer (160) cause any intermediary point to not have visibility into the payload of the packet(s).

In one or more embodiments of the invention, customer device (165) is any computing device capable of accessing internet (135) including, but not limited to: a laptop computer, a desktop computer, a cell phone, a smart phone, a tablet, a cable box, a handheld gaming device, etc. Customer device (165) may have any suitable components including, but not limited to: a CPU (not shown), memory (not shown), a Network Interface Card (NIC) (not shown), input devices (not shown), etc.

In one or more embodiments of the invention, end point optimizer (170) is module or program loaded into customer device (165) that operates similarly to site optimizer (160), except that it provides the functionality only to customer device (165). In other words, end point optimizer (170) includes functionality for performance tagging, tunneling, and security services. End point optimizer (170) is optional in the sense that if site optimizer (160) is present, then end point optimizer (170) is not required.

In one or more embodiments of the invention, overlay tunnel A (175A) and overlay tunnel B (175B) are overlay tunnels created by global VON WAN controller (115), and are part of the forwarding channel. Any packets sent using the method of this invention will travel over the overlay tunnels (i.e., overlay tunnel A (175A) and overlay tunnel B (175B)).

In one or more embodiments of the invention, connection group (180) is a closed user group of a Virtual Private Network (VPN) that is created by policy system application (110) in response to a customer/client request. Connection group (180) may describe the closed set of communication connection points and tunnel topology between one or more end-points for a given customer/client. In one or more embodiments of the invention, there may be any number of connection groups simultaneously, and each individual connection group is isolated from other connection groups.

In one or more embodiments of the invention, the above discussed components enable a highly secure connection to be created over existing, unsecure network components. In particular, due to the software defined nature of this invention, the security settings may be set, controlled, and/or managed by an owner or administrator, and may be used to integrate unsecure, public, network components into a pre-existing private (i.e., secure) network to enable the delivery of assured or enterprise services, and/or any other suitable service or data.

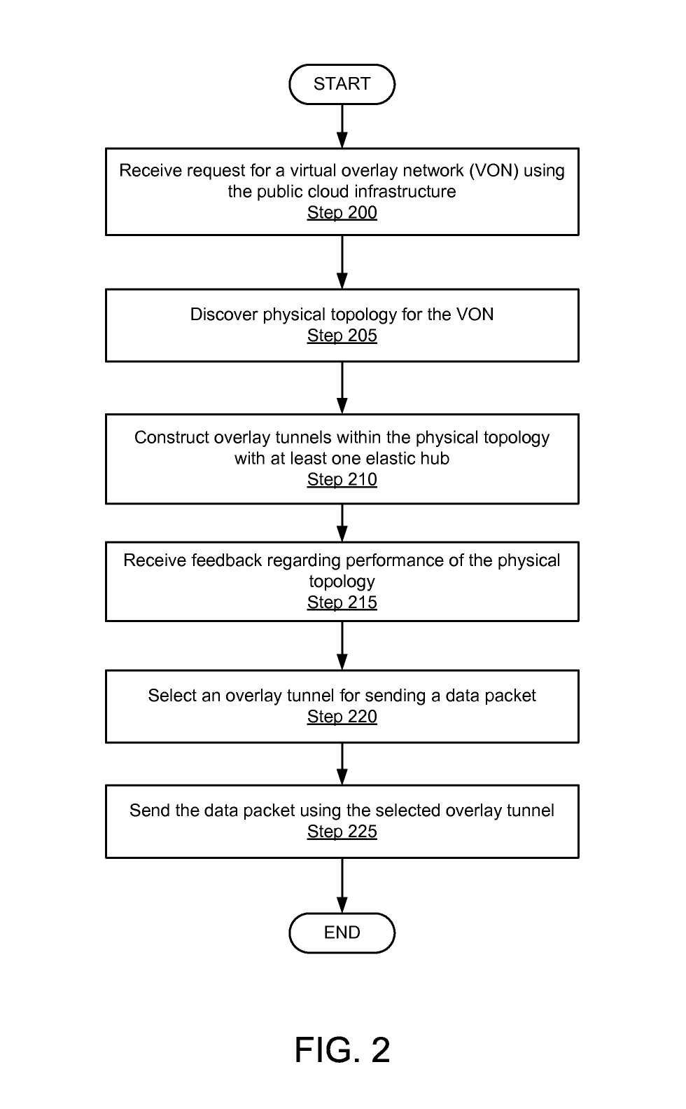

FIG. 2 shows a flowchart of a method for virtual overlay network architecture. While the various steps in this flowchart are presented and described sequentially, one of ordinary skill in the art will appreciate that some or all of the steps may be executed in different orders and some or all of the steps may be executed in parallel. Further, in one or more embodiments of the invention, one or more of the steps described below may be omitted, repeated, and/or performed in a, different order. Accordingly, the specific arrangement of steps shown in FIG. 2 should not be construed as limiting the scope of the invention.

In Step 200, a request for a VON using the public cloud infrastructure is received, in accordance with one or more embodiments of the invention. The request may be received, for example, from a customer using a computing device. In one or more embodiments of the invention, the request is received in any manner and/or format now known or later developed.

In Step 205, a physical topology for the VON is discovered, in accordance with one or more embodiments of the invention. Discovering the physical topology for the network may involve locating all site optimizer and end point optimizers that below to the connection group of the customer. In one or more embodiments of the invention, the physical topology is discovered using any method now known or later developed.

In Step 210, overlay tunnels are constructed within the physical topology with at least one elastic hub, in accordance with one or more embodiments of the invention. The overlay tunnels may be constructed with any number of elastic hubs, and any number of overlay tunnels may be constructed. In one or more embodiments of the invention, the overlay tunnels may use Generic Routing Encapsulation (GRE), Network Virtual Generic Routing Encapsulation (NVGRE), and/or any other suitable tunnel technology.

In Step 215, feedback is received regarding the performance of the physical topology, in accordance with one or more embodiments of the invention. The feedback may be received from any suitable component including, but not limited to, elastic hubs, site optimizers, and end point optimizers. The feedback may include any data or information related to how the underlying physical network is performing, and may be sent in any manner or format now known or later developed.

In Step 220, an overlay tunnel is selected for sending a data packet, in accordance with one or more embodiments of the invention. The overlay tunnel may be selected based on many different criteria, including but not limited to the selected tunnel being able to meet the requirements of the customer whose data is being sent over the overlay tunnel. In one or more embodiments of the invention, the selected overlay tunnel represents the shortest path from point to point. Alternatively, the selected overlay tunnel represents the fastest path from point to point. It will be apparent to one of ordinary skill in the art that there are many different ways to select which overlay tunnel should be used and, as such, the invention should not be limited to the above examples.

In Step 225, the data packet is sent using the selected overlay tunnel, in accordance with one or more embodiments of the invention. The data packet may be sent in any manner now known or later developed. In one or more embodiments of the invention, site optimizers and end point optimizers provide a security tunnel on top of the overlay tunnel that is being used, so that all intermediary points are unable to see the payload of the data packet, and so that customers may utilizes their own encryption keys and security settings.

In one or more embodiments of the invention, the above discussed method enable a highly secure connection to be created over existing, unsecure network components. In particular, due to the software defined nature of this invention, the security settings may be set, controlled, and/or managed by an owner or administrator, and may be used to integrate unsecure, public, network components into a pre-existing private (i.e., secure) network to enable the delivery of assured or enterprise services, and/or any other suitable service or data.

The following section describes various examples of the invention. The examples are included to aid in the understanding of the invention and are not intended to limit the scope of the invention.

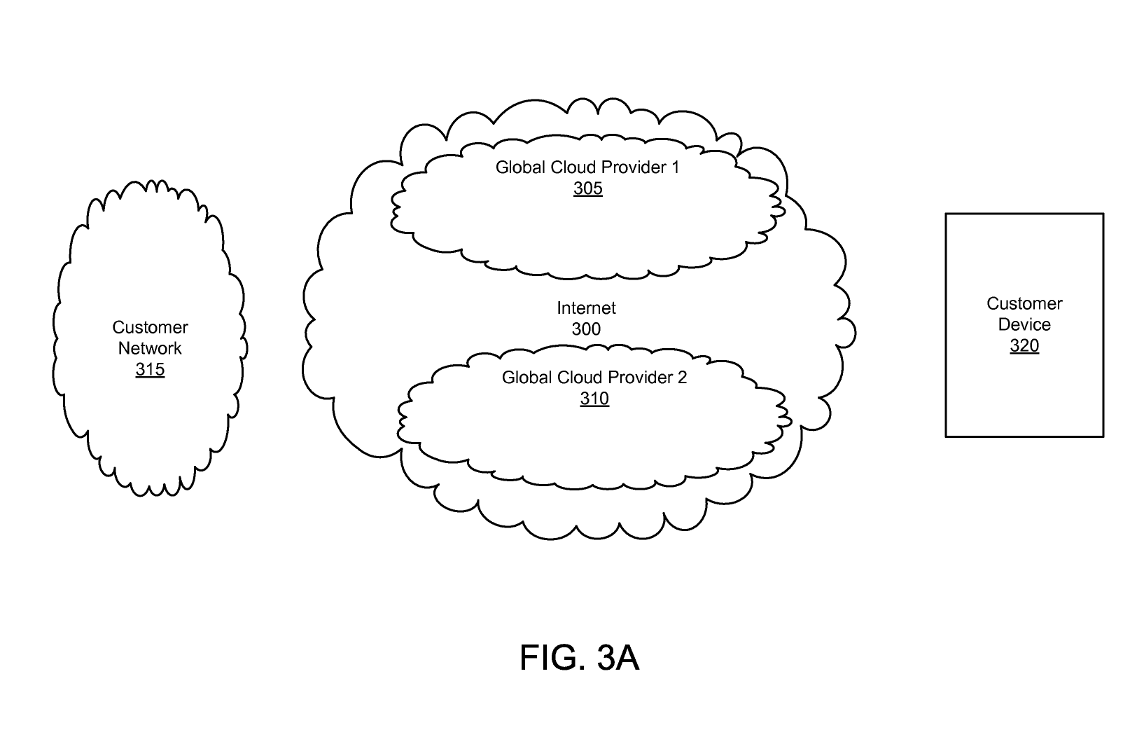

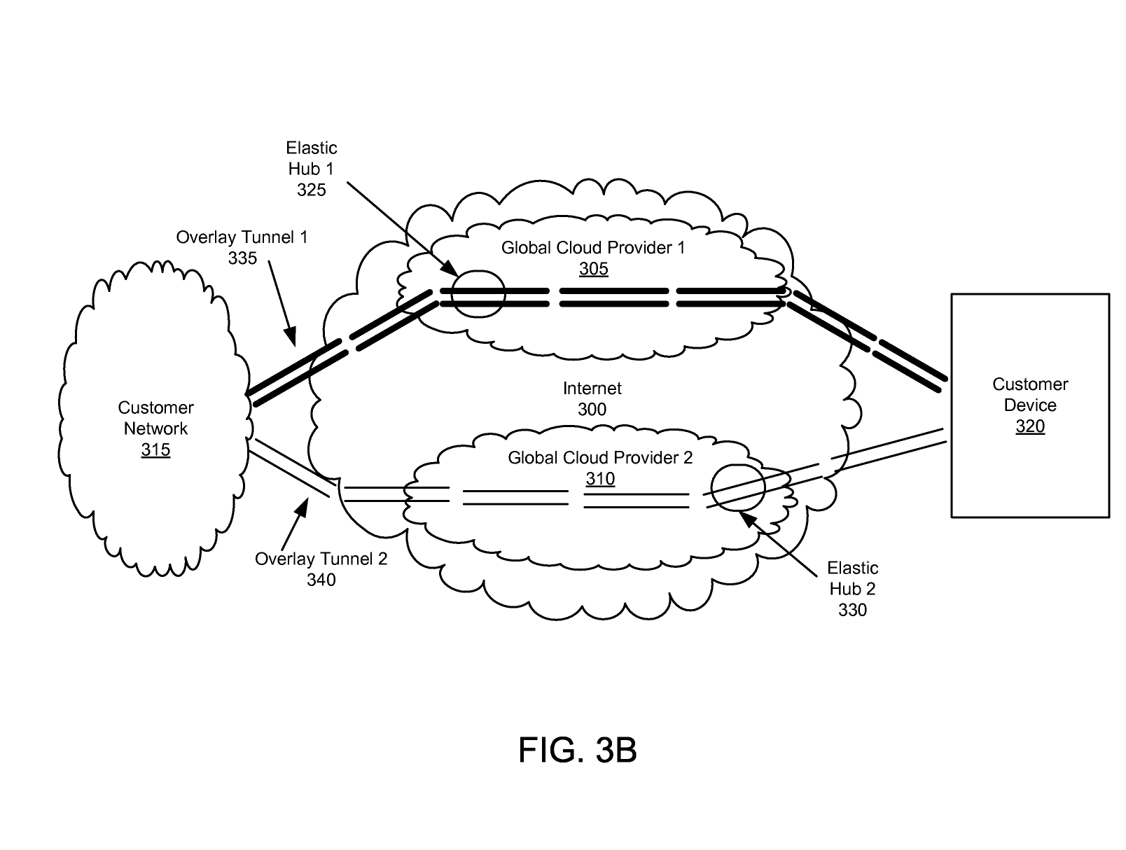

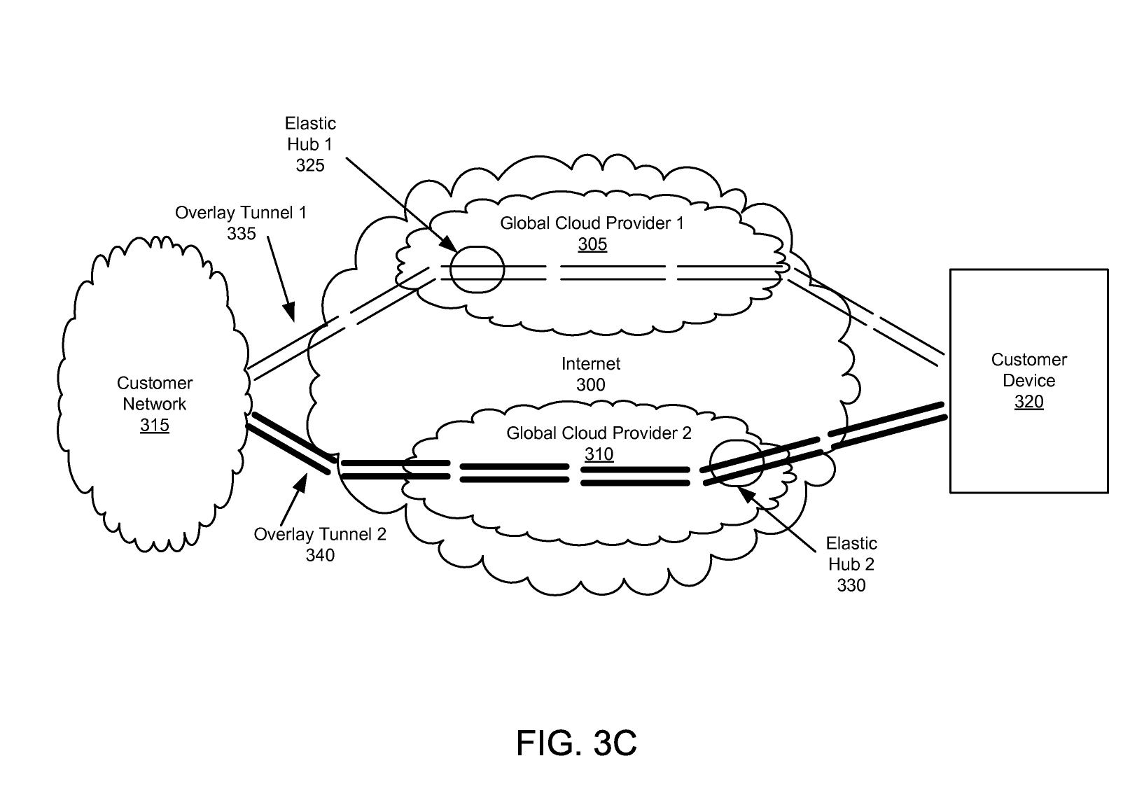

FIGS. 3A-3C show an example of a virtual overlay network architecture. Specifically, in FIG. 3A information needs to be sent from customer network (315) to customer device (320), utilizing internet (300), global cloud provider 1 (305), and global cloud provider 2 (310). To accomplish this, the customer sends a request for a virtual overlay network to the system of the present invention. In response to this request, the system maps out the physical topology, and creates overlay tunnels connecting customer network (315) and customer device (320), as shown in FIG. 3B. Specifically, elastic hub 1 (325) is deployed on global cloud provider 1 (305) as an intermediary forwarding node, while elastic hub 2 (330) is deployed on global cloud provider 2 (310), and overlay tunnel 1 (335) and overlay tunnel 2 (340) are created, thereby providing a forwarding channel to provide fast, secure communication between customer network (315) and customer device (320) on demand. The ability of elastic hubs to be deployed on pre-existing global cloud provider systems enables the invention to be remarkably far reaching in a very short amount of time. Additionally, the system only sends packets over one tunnel at a time and, in this example, the system has selected overlay tunnel 1 (335) to send the packets, as indicated by the bolded lines. Overlay tunnel 1 (335) was selected in this example because it provided the fastest path from customer network (315) to customer device (320).

Next, the example moves to FIG. 3C. As information is being sent over overlay tunnel 1 (335), feedback data is being sent from elastic hub 1 (325) and elastic hub 2 (330) to the system. Due to congestion, overlay tunnel 1 (335) begins to slow down, and ultimately is unable to satisfy the client's requirements, In response to this, the system switches to overlay tunnel 2 (340) for sending information (as indicated by the bolded lines), which is able to meet the client's requirements.

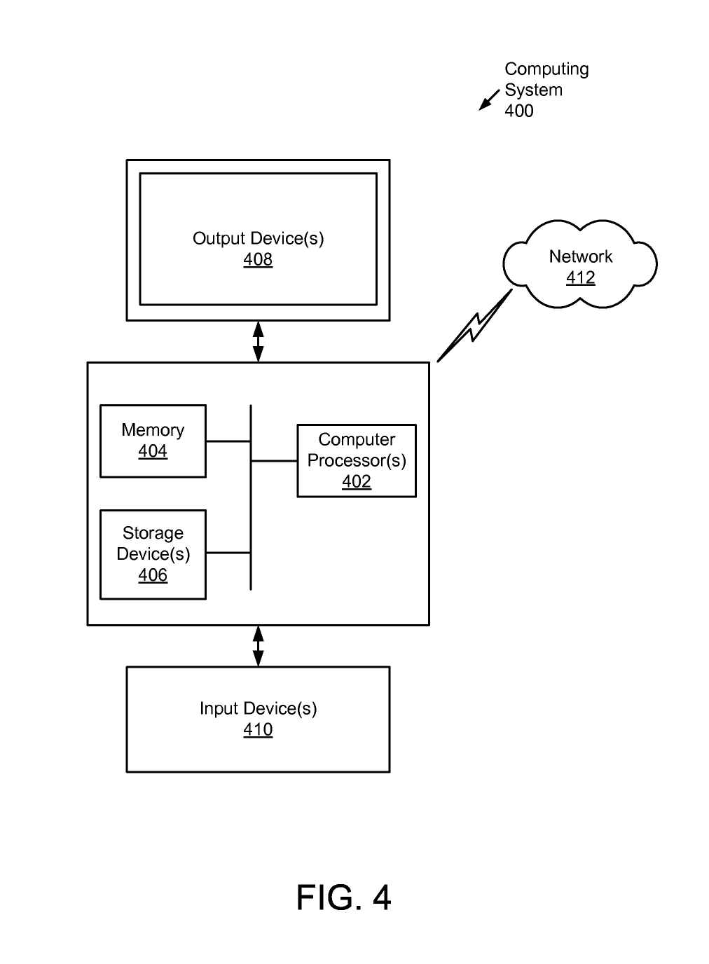

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for virtual overlay network architecture, comprising:
receiving a request for a virtual overlay network;
discovering, by a computer processor, a physical topology for the virtual overlay network;
constructing a plurality of overlay tunnels within the physical topology, wherein the overlay tunnels comprise at least one elastic hub;
receiving, by the computer processor, a feedback regarding performance of the physical topology of the virtual overlay network;
selecting a first overlay tunnel of the plurality of overlay tunnels for sending a data packet; and
sending the data packet using the first overlay tunnel.

2. The method of claim 1, further comprising:
creating, for the virtual overlay network, a connection group specifying communications allowed between a plurality of site optimizers and a plurality of end point optimizers.

3. The method of claim 2, wherein the physical topology comprises a plurality of physical paths between the plurality of site optimizers and the plurality of end point optimizers.

4. The method of claim 1, wherein the feedback is received from an elastic hub executing on a CPU of a global public cloud provider.

5. The method of claim 1, wherein the elastic hub executes on a Central Processing Unit (CPU) provided by a global cloud provider.

6. The method of claim 1, wherein the request comprises a Service Level Agreement (SLA).

7. The method of claim 6, further comprising:
determining, based on the feedback, that the first overlay tunnel is no longer satisfying a requirement of the SLA;
switching, in response to determining, from the first overlay tunnel to a second overlay tunnel of the plurality of tunnels; and
sending the data packet using the second overlay tunnel.

8. A non-transitory computer-readable storage medium storing a plurality of instructions for virtual overlay network architecture, the plurality of instructions comprising functionality to:
receive a request for a virtual overlay network;
discover a physical topology for the virtual overlay network;
construct a plurality of overlay tunnels within the physical topology, wherein the overlay tunnels comprise at least one elastic hub;
receive a feedback regarding performance of the physical topology of the virtual overlay network;
select a first overlay tunnel of the plurality of overlay tunnels for sending a data packet; and
send the data packet using the first overlay tunnel.

9. The non-transitory CRM of claim 8, the instructions comprising further functionality to:
create, for the virtual overlay network, a connection group specifying communications allowed between a plurality of site optimizers and a plurality of end point optimizers.

10. The non-transitory CRM of claim 9, wherein the physical topology comprises a plurality of physical paths between the plurality of site optimizers and the plurality of end point optimizers.

11. The non-transitory CRM of claim 8, wherein the feedback is received from an elastic hub executing on a CPU of a global public cloud provider.

12. The non-transitory CRM of claim 8, wherein the elastic hub executes on a Central Processing Unit (CPU) provided by a global cloud provider.

13. The non-transitory CRM of claim 8, wherein the request comprises a Service Level Agreement (SLA).

14. The non-transitory CRM of claim 13, the instructions comprising further functionality to:
determine, based on the feedback, that the first overlay tunnel is no longer satisfying a requirement of the SLA;
switch, in response to determining, from the first overlay tunnel to a second overlay tunnel of the plurality of tunnels; and
send the data packet using the second overlay tunnel.

15. A system for virtual overlay network architecture, comprising:
at least one elastic hub comprising functionality to:
forward packets;
a controller executing on a processor and comprising functionality to:
receive a request for a virtual overlay network;
discover a physical topology for the virtual overlay network;
construct a plurality of overlay tunnels within the physical topology, wherein the overlay tunnels comprise the at least one elastic hub;
receive a feedback regarding performance of the physical topology of the virtual overlay network;
select a first overlay tunnel of the plurality of overlay tunnels for sending a data packet; and
send the data packet using the first overlay tunnel.

16. The system of claim 15, further comprising functionality to:
create, for the virtual overlay network, a connection group specifying communications allowed between a plurality of site optimizers and a plurality of end point optimizers.

17. The system of claim 16, wherein the physical topology comprises a plurality of physical paths between the plurality of site optimizers and the plurality of end point optimizers.

18. The system of claim 15, wherein the feedback is received from an elastic hub executing on a CPU of a global public cloud provider.

19. The system of claim 15, wherein the elastic hub executes on a Central Processing Unit (CPU) provided by a global cloud provider.

20. The system of claim 15, further comprising functionality to:
determine, based on the feedback, that the first overlay tunnel is no longer satisfying a requirement of a SLA, wherein the request comprises the SLA;
switch, in response to determining, from the first overlay tunnel to a second overlay tunnel of the plurality of tunnels; and
send the data packet using the second overlay tunnel.
